(19) United States
(12) Patent Application Publication
(10) Pub. No.: US 2007/0001122 A1
(43) Pub. Date: Jan. 4, 2007

(54) Device with stacked electrodes for detecting radiation and method of detecting ionizing radiation that uses such a device

(75) Inventors: Eric Gros D'aillon, Brie et angonnes (FR); Loïck Verger, Grenoble (FR); Guillaume Montemont, Grenoble (FR)

Correspondence Address: BURR & BROWN, PO BOX 7068, SYRACUSE, NY, 13261-7068, US

(73) Assignee: Commissariat A L'Energie Atomique, Paris (FR)

(21) Appl. No.: 11/472,855

(22) Filed: Jun. 22, 2006

(30) Foreign Application Priority Data
Jul. 1, 2005 (FR) 05.52014

(51) Int. Cl. G01T 1/24

(52) U.S. Cl. 250/370.13

(57) ABSTRACT

This device for detecting ionizing radiation has a stacked structure comprising a first set of electrodes, a sensing element capable of interacting with the incident radiation to be detected by releasing mobile charges (electron-hole pairs) and a second set of electrodes, said first and second sets being intended to collect the mobile charges thus released. This stack also comprises a third set of electrodes intended to measure the charges induced by movement of the mobile charges, the electrodes in said third set being separated from those that constitute said second set by an electrically insulating layer defined so as to enable capacitive connection between the electrodes of said second set and the electrodes of said third set.

### FIELD OF INVENTION

The present invention relates to a device for detecting electromagnetic particle or wave ionizing radiation. Such a device is commonly used, firstly, primarily to detect this type of wave or particles for scientific purposes in particular and secondly to form images of certain parts of an object on the basis of rays transmitted through or diffracted or reflected by that object after irradiation in order, for instance, to analyze the chemical composition of that object.

### DESCRIPTION OF THE PRIOR ART

The use of a parallelepiped detection device, having two main directions, generally of the array type, in order to form images is known, especially in the field of X-ray or gamma ray imaging. The two main directions classically define a detection plane in which the detector makes it possible to localize the site at which the incident radiation interacts with the detector. The use of such detectors in order to form digital images, i.e. images coded as a sequence of computer bits, is also known.

Such a detector generally comprises an element that interacts with the incident radiation by releasing mobile electric charges and electrodes in which the charges thus released induce mobile charges. These electrodes generally include a unitary cathode that forms an equipotential assembly on the detection plane whereas the anodes consist of a plurality of juxtaposed points or pixels forming an array in the detection plane.

In order to make the anode and cathode measuring channels more compact, the anode points are grouped into electrically connected subsets so as to form equipotential lines (rows) and equipotential columns in the two main directions of the detection plane. To achieve this, the point-shaped anodes in fact comprise two adjacent elementary areas that are electrically isolated from each other, one of which is capable of being connected to a row of electrodes, the other of which is capable of being connected to a column of electrodes and are therefore capable of being brought to two different potentials.

The construction of such a detector comprises a stack of three different functional layers: the cathode layer, the sensing, detecting element, then a layer of point-shaped anodes.

To measure the characteristics of the charges induced in the electrodes, one channel has to be provided for every group of electrodes at a given potential. Thus, only one cathode channel is required for the detector but the number of measuring channels equals the number of different non-collecting anodes and electrodes. At the level of the non-collecting anodes and electrodes, the rows, on the one hand, and the columns, on the other hand, are biased to different potentials in order to distinguish them from each other when collecting the induced charges.

Because the sensing element and the subsets of electrodes are biased, the electrons that are released during interaction move and are collected by a row of anodes and electron displacement induces charge fluxes in the nearby column. Thus, charges induced by the charges released during interaction flow through the cathode channel and the non-collecting electrode channels that are the closest to the interaction site.

The term “non-collecting” is taken to mean an electrode that does not directly collect the charges released by interaction between radiation and the sensing element. In fact, the collecting electrodes are in electrical contact with the sensing element. The so-called “non-collecting” electrodes nevertheless collect induced charges.

For a given radiation, the row and column that collect charges therefore seem to intersect in the area of the interaction site. In reality, this row and this column do not touch but are connected to two adjacent elementary areas brought to two separate potentials, as stated earlier.

The cathode is used to detect the incident radiation energy, whereas the anodes which are more sensitive than the cathode, are used to localize the point of impact of the ray in the detection plane. This construction makes it possible to localize the interaction site of the incident radiation in the detection plane.

In addition, measuring certain parameters that characterize the charges collected by the cathode makes it possible to assess the depth of this interaction site. These parameters include, for instance, the energy or the duration that separates the anode signal from the cathode signal.

As shown in FIGS. 1 and 2, the two elementary electrode areas may, for example, be formed by a central disc 131 and a surrounding periphery 151 that are brought to the potential of a row 130 and the potential of a column 150 respectively. In order to maintain this potential difference between the disc and the periphery, an electrically insulating material forms a gap 141 between them. This insulating gap is such that the flow of charges collected in a disc 131 induces charges on the adjacent electrode 151, thereby generating a signal on each of the readout channels 139, 159, thus indicating the x and y coordinates of the location of the interaction site.

Nevertheless, such detection devices according to the prior art have drawbacks because they are limited in terms of the accuracy with which they can measure the energy of detectable radiation.

In fact, if the potential difference between two adjacent elementary electrode areas, i.e. between a given row and column, is too low, there is a risk that the released charges will not be collected correctly in the elementary areas. This absence of charge collection causes “dead zones” with no signal and this results in a reduced signal-to-noise ratio and hence deterioration in the quality of the image produced.

Conversely, if the potential difference between a given row and column is too high, there is a risk of the released charges being collected by the column which does not normally collect rather than being collected by the row in question. In this case, information is lost and this also results in a reduced signal-to-noise ratio and hence deterioration in the quality of the image produced.

With this type of detector according to the prior art, it is therefore necessary to select an appropriate potential difference between rows and columns. However, there is no satisfactory compromise because regardless of the potential difference applied, charges are lost on the collecting anodes and this results in reduced measurement accuracy.

In addition, detection devices according to the prior art as described above limit, because of their construction, the compactness of detectors despite current efforts to miniaturize them still further. In fact, in order to define rows and columns, it is necessary, as mentioned previously, to provide two areas of adjacent elementary electrodes in the same plane for each pixel with an insulating gap between each of these two areas.

### SUMMARY OF THE INVENTION

The object of the present invention is therefore to suggest a device for detecting radiation having a structure that makes it possible to produce images easily with a signal-to-noise ratio and resolution that are better than those of detectors according to the prior art whilst making it possible to make the detector more compact.

The invention therefore relates to a device for detecting ionizing radiation having a stacked structure comprising a first set of electrodes, a sensing element that interacts with incident radiation by releasing mobile charges (electron-hole pairs) and a second set of electrodes, said first and second sets being intended to collect the mobile charges thus released.

According to the invention, this stack also comprises a third set of electrodes intended to measure the charges induced by movement of the mobile charges generated by interaction between the incident radiation and the sensing element, the electrodes in said third set being separated from those that constitute said second set by an electrically insulating layer defined so as to enable capacitive connection between the electrodes of said second set and the electrodes of said third set.

In other words, the detector that is the subject of the present invention comprises five stacked layers. Because of this construction, the elementary areas of two separate subsets of electrodes, collecting and non-collecting electrodes, are no longer juxtaposed in the same plane but are offset substantially at right angles relative to the detection plane. They are also separated from each other by an electrically insulating layer and are therefore capacitively connected.

Consequently, electrons cannot be collected by the non-collecting electrodes. In addition, miniaturization of the elementary electrodes can be improved compared with the prior art because it is no longer necessary to provide two adjacent areas having two different potentials in the same plane.

In practice, the first set can be formed by a single electrode or several electrodes. In other words, the cathode may or may not be segmented. Cathode segmentation makes it possible to reduce the number of readout anode channels required considerably, thereby making the detector more compact. Consequently, the second set is formed by several electrodes.

According to one advantageous embodiment of the invention, the electrodes of the second set are electrically connected to each other so as to form rows that are substantially parallel to each other. Similarly, the electrodes of the third set are electrically connected to each other so as to form columns that are substantially parallel to each other and extend transversely relative to said rows.

In other words, a layer of collecting anodes consists of juxtaposed rows and a layer of non-collecting electrodes consists of columns that are transverse relative to these rows. This construction makes it possible to make the detector more compact and allows the interaction site to be interpolated easily in the plane.

Advantageously, the rows are perpendicular to the columns. This makes it possible to minimize the quantity of material required to produce these rows and columns.

According to one advantageous embodiment of the invention, the electrically insulating layer and the third set are pierced by holes so as to accommodate means of electrical contact with each of the elementary electrodes that constitute the second set.

In this way, one can easily control the capacitive connections defined by the insulating layer 640 between the collecting electrodes 630 and the non-collecting electrodes 650.

According to another embodiment of the invention, the elementary electrodes of the third set may be electrically connected to each other so as to form electrically contiguous subsets that are isolated from each other. In this configuration, each of the subsets can be connected to the same number of elementary electrodes of the second set and to a measuring channel. In addition, the elementary electrodes of the second set may be connected to each other discretely and are electrically interconnected so as to constitute a plurality of collecting subsets, each of these collecting subsets being electrically connected to one measuring channel. Two elementary electrodes that belong to the same collecting subset are each positioned opposite two separate non-collecting subsets, thus defining two capacitive connections.

In other words, the electrodes of the third set can be electrically connected to each other so as to form rectangles that are each brought to the potential of a measuring channel. In addition, each of these rectangles can be located opposite a specified number of electrodes of the second set, thus defining, with them, an equivalent number of capacitive connections. The elementary electrodes of the second set may, in turn, form discrete equipotential sequences that are each connected to one measuring channel. This construction makes it possible to achieve a device that is more compact than those according to the prior art.

In practice, the sensing element consists of cadmium telluride, especially CdTe or CdZnTe. It is known that this material has good sensitivity to the radiation to be detected. It may also be made of a material selected from the group comprising: HgI₂, AsGa and Se.

The object of the present invention is also a method of detecting ionizing radiation by means of a detection device as described above.

According to the invention, this method involves:
taking measurements of the amplitudes of the signals acquired in the measuring channels of the first and/or second and/or third set of electrodes;
deducing the energy of the incident radiation from the measurements of the signals acquired in the measuring channels of the first and second sets of electrodes;
deducing the location of the interaction site in a plane parallel to the surface of the electrodes from the measurements of the signals acquired in the measuring channels of the second and third sets of electrodes;
assessing the depth of the interaction site on the basis of the signals acquired in the measuring channels of the first set of electrodes or of the first and the second sets of electrodes or of the third set of electrodes.

Advantageously, said method also involves:
assessing the dynamic parameters that characterize the displacement and quantity of charges flowing through the electrodes of said second and third sets,
deducing from these assessments, the depth of the interaction site in said element and the position of said site in a plane that is parallel to the surface of the electrodes.

In concrete terms, this involves conventional methods of measurement that are appropriate to the detection device that is the subject of the invention. These measurements make it possible to determine the x and y coordinates of the interaction site in the detection plane as well as its depth in the element.

In practice, the dynamic parameters may comprise the variation times of the signals on the electrodes of said first, second and/or third sets as well as the maximum charge and the final charge induced on the electrodes of said third set. These charges are determined conventionally by measuring a voltage on the electrodes in question.

These parameters, taken individually or in combination, make it possible to determine the x and y coordinates of the interaction site in the detection plane as well as its depth in the element.

### BRIEF DESCRIPTION OF THE DRAWINGS

In order that the way in which the invention is implemented and its resulting advantages may more readily be understood, the following description is given, merely by way of example, reference being made to the accompanying drawings.

FIG. 1 is a schematic perspective view of a detection device according to the prior art.

FIG. 2 is a schematic view of a detail in FIG. 1.

FIG. 3 is a schematic exploded perspective view of a detection device according to the invention.

FIG. 4 is a schematic cross-sectional view along line 1-1 of the detection device in FIG. 3.

FIG. 5 is a schematic cross-sectional view along line 2-2 of the detection device in FIG. 3.

FIG. 6 is a schematic exploded perspective view of a preferred embodiment of the detection device in FIG. 3.

FIG. 7 is a schematic front view of the detection device in FIG. 6.

FIG. 8 is a schematic cross-sectional view of a detection device in accordance with a second embodiment of the invention.

### DESCRIPTION OF THE PREFERRED EMBODIMENT

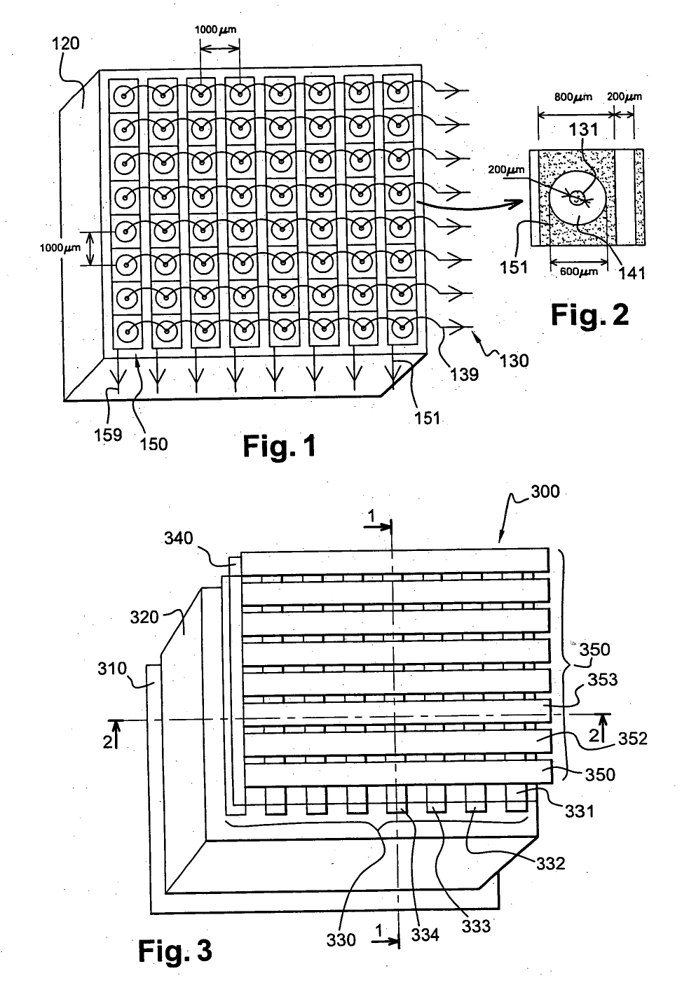

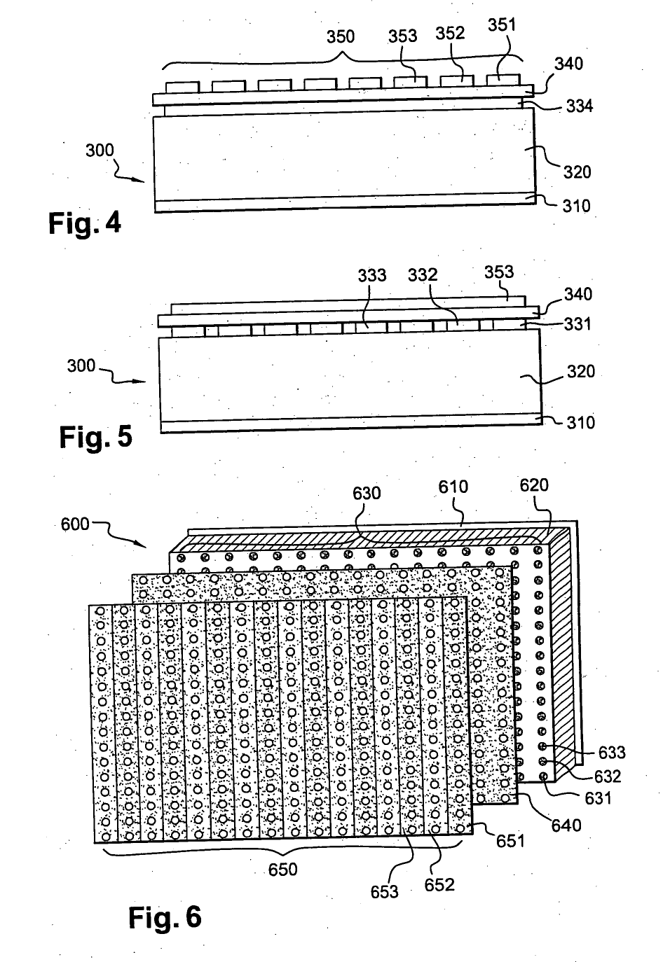

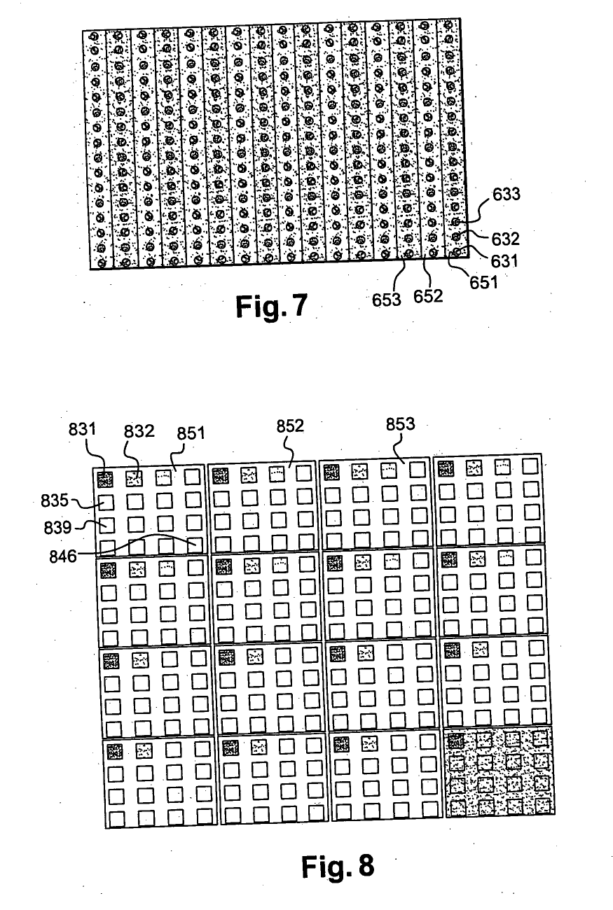

FIG. 1 shows a detection device 300 in accordance with the invention. This detector comprises a stack consisting of a first set of electrodes 310, namely a unitary cathode, a sensing element 320, consisting of a layer of material that is sensitive to the radiation to be detected, such as an alloy of cadmium, zinc and tellurium (CdZnTe) as well as a second set of electrodes 330 and a third set of electrodes 350, namely consisting of columns 331-338 and rows 351-358 of electrodes respectively.

According to the invention, the second and third sets of electrodes are separated by a layer made of an electrically insulating material 340 so as to define capacitive connections between their opposite-facing electrodes.

The material that constitutes insulating layer 340 typically consists of ZnS, SiO₂ or even a plastic marketed under the registered trademark KAPTON®. This insulating layer 340 is chosen so that the relative permittivity (εr)-to-thickness ratio of the insulating layer (1) is both sufficiently high to ensure that the expected signal is strong and sufficiently low not to generate excessive noise. This ratio will depend on the geometry of the detector. Those skilled in the art are capable of depositing a sufficiently fine insulating layer to ensure that the permittivity is low. This choice is essentially the result of technical considerations.

For example, if one uses a KAPTON® type insulating plastic having a relative permittivity of 3, the thickness of insulating layer 340 must not exceed 250 μm.

Using an insulating material with a higher permittivity of around 10, for example, the thickness of insulating layer 340 must be less than 500 μm.

Using an oxide type insulating material with a higher permittivity of around 20, the thickness of said layer must be less than 1 mm.

This layer may also consist of several superimposed layers of different insulating materials.

Also, sensing element 320 has, in the example described, a thickness of the order of 5 mm.

When radiation interacts with sensing element 320, the latter is ionized, i.e. it releases one or more charges (not shown), namely electron-hole pairs. These positive and negative charges are mobile and move depending on the way that sets of electrodes 310 and 330 of the detector are biased. The positive charges move towards cathode 310 whereas the negative charges consisting of released electrons move towards one of the collecting columns, namely column 334. The sets of electrodes are biased in a manner that is known in itself. The columns 331-338 and the rows 351-358 are brought to different potentials.

In this way, the electrons are collected and then routed to the readout channel (not shown) of collecting column 334. One can then collect these electrons and use appropriate electronic means to characterize them (number, energy, signal propagation delay etc.) in order to be able to determine the x coordinate of the radiation interaction site precisely.

As a result of displacement of electrons in sensing element 320, charges are induced and are captured through the capacitive connection, defined by insulating layer 340, in non-collecting rows 351-358 of the third set of electrodes 350. One can then collect these induced charges and use appropriate electronic means to characterize them (number, energy, signal propagation delay etc.) in order to be able to determine the y coordinate of the radiation interaction site precisely.

With this x and this y coordinate, one can then deduce the location of the radiation interaction site in a notional detection plane located in sensing element 320. One can also, in a manner which is known in itself, code the x and y coordinate signals as bits in order to then reconstitute a digital image of the emitted radiation after it has been diffracted, transmitted or reflected by an object which one wishes to observe.

In addition, displacement of the electrons induces a charge on unitary cathode 310 which makes it possible, in conjunction with the signals of the subsets of collecting and non-collecting electrodes, to determine the depth of the radiation interaction site in the sensing element.

Because of the construction of detector 300 consisting of stacked layers 310, 320, 330, 340 and 350, the elementary areas of two separate subsets of electrodes, collecting 330 and non-collecting 350 electrodes, are no longer juxtaposed in the same plane but are offset to each other substantially at right angles relative to the detection plane. Whereas detectors according to the prior art have adjacent elementary areas in one detection plane (see FIGS. 1 and 2), electrodes 330 and 350 are offset at right angles relative to the detection plane in detector 300.

As described above, they are also separated by an insulating layer 340 and are therefore connected by a capacitive connection. Consequently, electrons cannot be collected by the non-collecting electrodes. Detector 300 is therefore capable of collecting more signals and therefore has a signal-to-noise ratio, and hence repeatability, that is better than that of detectors according to the prior are for subsets of electrodes having identical dimensions.

Similarly, miniaturization of the elementary electrodes 331-338 can be improved compared with the prior art because it is no longer necessary to provide two adjacent areas having two different potentials in the same plane. Thus, the gap that separates the elementary collecting and non-collecting areas in detectors according to the prior art is no longer situated in a detection plane but at right angles to this plane. Because of this, it is possible to define elementary collecting anodes or pixels that are smaller, thus improving detection resolution. In this way, the detection device that is the subject of the invention makes it possible to obtain spatial resolution that is less than the electrode pitch spacing.

In the embodiment example shown in FIG. 6, the structure of the detector in FIG. 3 is reproduced but with the difference that the insulating sheet 640 and subsets 651, 652, 653 of the third set of electrodes 650 are pierced to allow means of electrical contact with the elementary anodes of the second set 630 to pass through. These means of contact are in the form of pins or projections 631, 632, 633 etc.

This particular structure of the contacts between the elementary collecting anodes 631, 632, 633 and their readout channels (not shown) makes it possible to easily control the capacitive connection defined by the insulating layer 640 between the collecting electrodes 630 and the non-collecting electrodes 650. In fact, the capacitive noise and noise due to the leakage current can be reduced compared with the embodiment described in relation to FIG. 3 because the non-collecting electrodes are less “masked” or isolated by the anode layer.

FIG. 8 shows an alternative embodiment of the device according to the invention. In this case, the electrodes of the third set 850 are electrically connected to each other so as to form electrically contiguous rectangular subsets that are isolated from each other 851, 852, 853 etc. Every subset is capacitively connected to 16 elementary anodes 831-846 of the second set of electrodes. In addition, each of the non-collecting subsets is brought to the potential of the measuring channel to which it is electrically connected.

Also, the elementary anodes of the second set can be interconnected and connected to a measuring channel discretely. These elementary anodes are also electrically interconnected so as to constitute a plurality of collecting subsets, each of these collecting subsets being electrically connected to a measuring channel. Two elementary electrodes that belong to the same collecting subset are each positioned opposite two separate non-collecting subsets, thus defining two capacitive connections. This construction makes it possible to achieve a device that is more compact than those according to the prior art.

Obviously, other circuit diagrams can be envisaged within the scope of the present invention. Similarly, other materials or other dimensions may be adopted in order to build the detection device which can be used for any type of ionizing radiation such as x-rays, gamma rays, alpha particles, neutrons etc.

Also, each of these detection devices involves using methods for detecting ionizing radiation. These methods involve operations to read the signals output by the detector.

These operations involve, in particular, taking measurements of the amplitudes of the signals acquired for the first and/or second sets of electrodes. The amplitude of the signals is equivalent to the quantity of induced charges. One deduces the energy of the incident radiation from this measurement.

The interaction site in a plane parallel to the surface of the electrodes must then be localized. This is achieved by taking measurements of the amplitudes of the signals acquired on the anodes and on the non-collecting electrodes. The interaction site is located at the point where the subsets through which the charges, released or induced by the interaction flow, intersect.

Finally, thanks to signals S1 (signals from first set of electrodes) or S1 and S2 (signals from second set of electrodes) or even S3 (signals from third said of electrodes), one can deduce the depth of the interaction site in said element.

In order to improve determination of the interaction site in the plane parallel to the electrodes and by depth, one can also measure dynamic parameters, especially the duration of variation of the signals (“rise-time”) on the electrodes of the first, second and/or third sets (cathode, anodes, non-collecting electrodes). These parameters also include the ratio of the amplitude measured on the cathode (first set) to that measured on the anode (second set) as well as the maximum charge, final induced charge and final current on the non-collecting electrodes of the third set.

For those skilled in the art, making these measurements or selecting appropriate electronic modules poses no difficulty. All the charge measurements are, for instance, deduced from measurements of the potentials and currents on the electrodes.

1. A device for detecting ionizing radiation comprising a stacked structure consisting of a first set of electrodes (310; 610), a sensing element (320; 620) capable of interacting with the incident radiation to be detected by releasing mobile charges (electron-hole pairs) and a second set (330; 630; 830) of electrodes (331; 631; 831 etc;), said first and second sets being intended to collect the mobile charges thus released, wherein said stack also comprises a third set (350; 650; 850) of electrodes (351; 651; 851 etc.) intended to measure the charges induced by movement of said mobile charges, the electrodes (351; 651; 851 etc.) of said third set (350; 650; 850) being separated from those that constitute said second set (330, 630, 830) by a layer (340, 640) made of an electrically insulating material defined so as to allow formation of a capacitive connection between electrodes (331; 631; 831 etc.) of said second set (330; 630; 830) and the electrodes (351; 651; 851 etc.) of said third set (350; 650; 850).

2. A device for detecting ionizing radiation as claimed in claim 1, wherein the first set of electrodes (310; 610) is formed by a single electrode or several electrodes and wherein the second set (330; 630; 830) is formed by several electrodes.

3. A device for detecting ionizing radiation as claimed in claim 1, wherein the electrodes (331; 631; 831 etc.) of the second set (330; 630; 830) are electrically connected to each other so as to form rows that are substantially parallel to each other and wherein the electrodes (351; 651; 851 etc.) of the third set (350; 650; 850) are electrically connected to each other so as to form columns that are substantially parallel to each other and extend transversely relative to said rows in the detection plane.

4. A device for detecting ionizing radiation as claimed in claim 3, wherein the rows are at right angles to the columns.

5. A device for detecting ionizing radiation as claimed in claim 1, wherein the layer made of an electrically insulating material (340; 640) and the third set (350; 650; 850) are pierced so as to accommodate means of electrical contact with each of the electrodes (331; 631; 831 etc.) of the second set (330; 630; 830).

6. A device for detecting ionizing radiation as claimed in claim 1, wherein:
the electrodes (351; 651; 851 etc.) of the third set (350; 650; 850) are electrically connected to each other so as to form electrically contiguous subsets that are isolated from each other, said subsets being connected to the same number of electrodes (331; 631; 831 etc.) of the second set (330; 630; 830) and to a measuring channel,
and wherein the electrodes (331; 631; 831 etc.) of the second set (330; 630; 830) are connected to each other discretely,
and wherein said electrodes (331; 631; 831 etc.) of second set (330; 630; 830) are electrically interconnected so as to constitute a plurality of collecting subsets, each of these collecting subsets being electrically connected to a measuring channel,
and wherein two electrodes that belong to the same collecting subset are each positioned opposite two separate non-collecting subsets, thus defining two capacitive connections.

7. A device for detecting ionizing radiation as claimed in claim 1, wherein the sensing element (320, 620) is made of a material chosen from the group comprising cadmium telluride, with or without the addition of zinc: CdTe or Cd ZnTe, HgI₂, AsGa and Se.

8. A device for detecting ionizing radiation as claimed in claim 1, wherein the material that constitutes the insulating layer (340; 640; 840) is chosen from the group comprising plastic, ZnS and SiO₂.

9. A method for detecting ionizing radiation that uses a detection device as claimed in claim 1, wherein it involves the following operations:
measuring the amplitudes of the signals acquired on said first and/or second and/or third sets of electrodes (310; 330; 350; 610; 630; 650; 810; 830; 850);
deducing the energy of the incident radiation from the measurements of the signals acquired on said first and second sets of electrodes;
localizing the interaction site in a plane parallel to the surface of the electrodes from measurement of the amplitudes of the signals acquired on said second and third sets of electrodes;
assessing the depth of the interaction site on the basis of measurements of the amplitudes of the signals acquired either on the first set of electrodes or on the first and second sets of electrodes or on the third set of electrodes.

10. A method for detecting ionizing radiation as claimed in claim 9, wherein it also comprises another operation involving measuring the dynamic parameters that characterize the displacement and quantity of charges flowing through the electrodes of said second and third sets (330, 350; 630, 650; 830, 850) in order to deduce from these the depth of the interaction site in said element and its position in the plane parallel to the surface of the electrodes.

11. A method for detecting ionizing radiation as claimed in claim 10, wherein said dynamic parameters comprise the variation times of the signals on the electrodes of said first, second and/or third sets (310, 330, 350; 610, 630, 650; 810, 830, 850), the maximum charge and the final charge induced on the electrodes of said third set.
